(19) United States
(12) Patent Application Publication
(10) Pub. No.: US 2013/0249424 A1
(43) Pub. Date: Sep. 26, 2013

(54) LIGHT EMITTING DIODE DRIVING APPARATUS

(71) Applicants: Jung Eui PARK, Suwon (KR); Seung Kon Kong, Suwon (KR); Joon Youp Sung, Suwon (KR); Jae Shin Lee, Suwon (KR); Jin Soo Lee, Suwon (KR); Jung Sun Kwon, Suwon (KR)

(72) Inventors: Jung Eui PARK, Suwon (KR); Seung Kon Kong, Suwon (KR); Joon Youp Sung, Suwon (KR); Jae Shin Lee, Suwon (KR); Jin Soo Lee, Suwon (KR); Jung Sun Kwon, Suwon (KR)

(73) Assignee: SAMSUNG ELECTRO-MECHANICS CO., LTD.

(21) Appl. No.: 13/494,497

(22) Filed: Jun. 12, 2012

(30) Foreign Application Priority Data
Mar. 21, 2012 (KR) 10-2012-0029001

(51) Int. Cl. H05B 37/02

(52) U.S. Cl. 315/201

(57) ABSTRACT

There is provided a light emitting diode driving apparatus capable of uniformly controlling current balance between light emitting diode channels. The light emitting diode driving apparatus includes: an AC to DC converting unit converting input AC power into a preset DC driving power; a detecting unit detecting voltage drops generated in a plurality of respective light emitting diode channels each having a plurality of light emitting diodes performing a light emitting operation by receiving the DC driving power; a converting unit converting analog values detected from the detecting unit into digital values; and a driving unit differentially setting switching signal duty cycles in which a driving current is allowed to flow in the plurality of respective light emitting diode channels according to the digital values from the converting unit to drive the plurality of light emitting diode channels.

### CROSS-REFERENCE TO RELATED APPLICATIONS

This application claims the priority of Korean Patent Application No. 10-2012-0029001 filed on Mar. 21, 2012, in the Korean Intellectual Property Office, the disclosure of which is incorporated herein by reference.

### BACKGROUND OF THE INVENTION

1. Field of the Invention

The present invention relates to a light emitting diode driving apparatus capable of uniformly controlling current balance between light emitting diode channels.

2. Description of the Related Art

Recently, interest in and a demand for light emitting diodes (LEDs) has increased.

Since a device using a light emitting diode may be manufactured to be compact, it may be used even in a location in which it is difficult for an existing electronic product to be installed. In the case in which a device using the light emitting diode is used as a general lighting device, since light of varied colors and illumination intensities may easily be implemented in a device using the light emitting diode, it may be used in a lighting device or system suitable for use in a situation such as displaying a movie, reading a book, holding a meeting, or the like.

In addition, a lighting device or system using the light emitting diode consumes an amount of power corresponding to ⅛ of that consumed by an incandescent lamp, has a lifespan of 50 to 100 thousand hours, corresponding to a lifespan 5 to 10 times that of an incandescent lamp, is a mercury-free light source, is environmentally-friendly, and may be variably implemented.

Due to these characteristics, a light emitting diode lighting business has been promoted through national policy initiatives in countries such as Korea, the USA, Japan, Australia, and others.

Moreover, in accordance with the recent development of flat panel display technology, a flat panel display has also been used for automobile dashboard displays, as well as for smart phones, game machines, and digital cameras. In the future, the use of flat panel displays is projected to increase in fields related to personal life, such as in ultrathin-type televisions, transparent navigation devices, and the like. Further, in the current display field, new flat panel displays (FPDs), reflecting the requirements of the multimedia age, such as high resolution, large screens, and the like, have mainly been developed. Particularly, in the case of a large display, a liquid crystal display (LCD) TV has rapidly been developed, such that it will be expected that LCDs will play a leading role in the development of many products in view of the cost and marketability thereof in the future.

A thin film transistor liquid crystal display (TFT-LCD) is mainly used in a flat panel display. The TFT-LCD includes a backlight unit emitting light, and mainly uses a cold cathode fluorescent lamp (CCFL) as a backlight light source. However, recently, the use of a light emitting diode (LED) has been gradually increased due to various strengths such as low power consumption, long lifespan, environmental-friendliness characteristics, and the like. Therefore, a configuration of a low-cost and low-power electronics system for a backlight unit power module using an LED and an appropriate controlling element therefor have been urgently demanded.

As described above, a light emitting diode that tends to be increasingly used requires a driving apparatus for driving the light emitting diode. According to the related art, a switching element has mainly been used in order to control respective LED channels with a constant current. However, as disclosed in the following related art document, since respective LED channels are configured to include a plurality of LEDs connected in series, thereby causing a voltage deviation between the LEDs, current unbalance is generated between the LED channels, such that brightness of the light emitting diode driving apparatus may not be uniform.

### RELATED ART DOCUMENT

US Patent Application Publication No. US 2011/0309758

### SUMMARY OF THE INVENTION

An aspect of the present invention provides a light emitting diode (LED) driving apparatus capable of differentially setting duty cycles in which a driving current is allowed to flow in respective LED channels, according to voltage deviations therebetween, in order to reduce heat generated due to the voltage deviations between the LED channels.

According to an aspect of the present invention, there is provided a light emitting diode driving apparatus, including: an alternating current (AC) to direct current (DC) converting unit converting input AC power into DC driving power having a preset voltage level; a detecting unit detecting voltage drops generated in a plurality of respective light emitting diode channels each having a plurality of light emitting diodes performing a light emitting operation by receiving the DC driving power; a converting unit converting analog values detected by the detecting unit into digital values; and a driving unit differentially setting switching signal duty cycles in which a driving current is allowed to flow in respective light emitting diode channels, according to digital values converted by the converting unit, to drive the plurality of light emitting diode channels.

The detecting unit may include a plurality of detectors respectively corresponding to the plurality of light emitting diode channels and detecting the voltage drops of a corresponding light emitting diode channel.

The driving unit may include a plurality of drivers respectively corresponding to the plurality of light emitting diode channels and setting the duty cycles of the switching signals by which the driving current is allowed to flow in a corresponding light emitting diode channel to thereby be driven.

The converting unit may include a plurality of converters corresponding to the plurality of detectors and converting the analog value detected by each of the plurality of detectors into the digital value to transfer the converted digital value to a corresponding driver among the plurality of drivers.

The driving unit may lengthen a switching-on duty cycle when the voltage drop exceeds a reference voltage and shorten the switching-on duty cycle when the voltage drop is lower than the reference voltage.

The detecting unit, the converting unit, and the driving unit may be configured by at least one integrated circuit.

The light emitting diode driving apparatus may further include a plurality of switches respectively connected between each of the plurality of light emitting diode channels and a ground, and turned on and turned off according to the switching duty cycle set by the driving unit to drive the corresponding light emitting diode channel.

The light emitting diode driving apparatus may further include a plurality of buffers buffering a switching duty cycle signal from the driving unit to transfer the buffered switching duty cycle signal to a corresponding switch.

According to another aspect of the present invention, there is provided a light emitting diode driving apparatus, including: an AC to DC converting unit converting input AC power into a preset DC driving power; a detecting unit detecting voltage drops generated in a plurality of respective light emitting diode channels each having a plurality of light emitting diodes performing a light emitting operation by receiving the DC driving power; a converting unit converting analog values detected from the detecting unit into digital values; a driving unit differentially setting switching signal duty cycles by which a driving current is allowed to flow in the plurality of respective light emitting diode channels, according to digital values from the converting unit, to drive the plurality of light emitting diode channels; and a switching unit selecting a detection value from each of a plurality of detectors to transfer the selected detection value to the converting unit and selecting the digital value from the converting unit to transfer the selected digital value to each of a plurality of drivers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram showing alight emitting diode driving apparatus according to an embodiment of the present invention;

FIG. 2 is a diagram showing alight emitting diode driving apparatus according to another embodiment of the present invention;

FIG. 3 is a graph showing an operation of the light emitting diode driving apparatus according to the embodiment of the present invention; and

FIG. 4 is a schematic configuration diagram of a compensating unit used in the light emitting diode driving apparatus according to an embodiment of the present invention.

### DETAILED DESCRIPTION OF THE EMBODIMENTS

Hereinafter, embodiments of the present invention will be described in detail with reference to the accompanying drawings so that they can be easily practiced by those skilled in the art to which the present invention pertains.

However, in describing embodiments of the present invention, detailed descriptions of well-known functions or constructions will be omitted so as not to obscure the description of the present invention with unnecessary detail.

In addition, like or similar reference numerals denote parts performing similar functions and actions throughout the drawings.

A case in which any one part is connected to the other part includes a case in which the parts are directly connected to each other and a case in which the parts are indirectly connected to each other with other elements interposed therebetween.

In addition, unless explicitly described otherwise, “comprising” any components will be understood to imply the inclusion of other components but not the exclusion of any other components.

Embodiments of the present invention will now be described in detail with reference to the accompanying drawings.

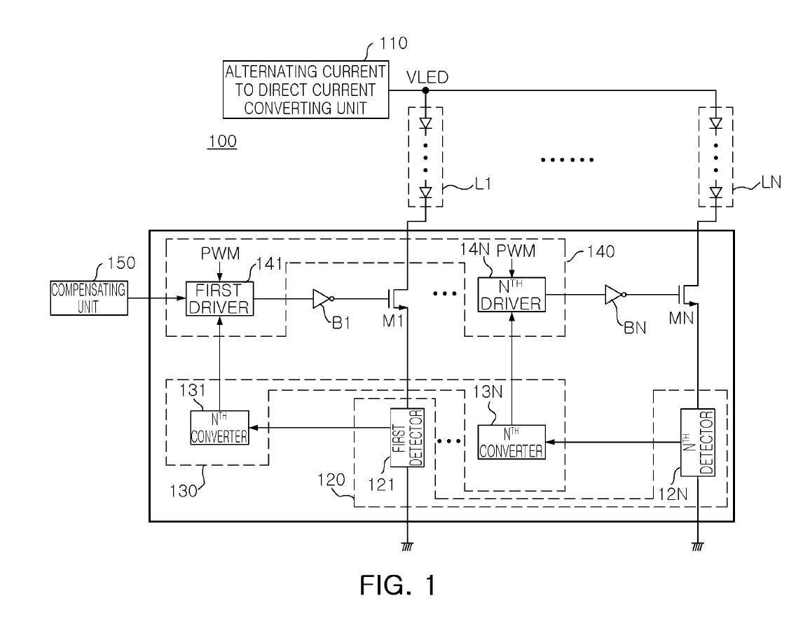

FIG. 1 is a diagram showing a light emitting diode driving apparatus according to an embodiment of the present invention.

Referring to FIG. 1, the light emitting diode driving apparatus 100 according to the embodiment of the present invention may include an alternating current (AC) to direct current (DC) converting unit 110, a detecting unit 120, a converting unit 130, and a driving unit 140.

The AC to DC converting unit 110 may convert input AC power into a preset driving power to transfer the preset driving power to each of a plurality of light emitting diode channels L1 to LN.

The detecting unit 120 may detect voltage drops in the plurality of light emitting diode channels L1 to LN, each having a plurality of light emitting diodes connected in series. The plurality of light emitting diode channels L1 to LN may allow the plurality of light emitting diodes corresponding thereto to emit light by receiving the DC driving power VLED having a preset voltage level, respectively. In this case, each of the light emitting diodes may drop a voltage level of the received power, wherein voltage drop values of the respective light emitting diodes may be different. The detecting unit 120 may detect voltage drop values between the plurality of light emitting diode channels L1 to LN and include a plurality of detectors 121 to 12N corresponding to the plurality of light emitting diode channels L1 to LN to respectively detect voltage drop values of the plurality of light emitting diode channels L1 to LN.

The converting unit 130 may convert analog detection values, detected in the detecting unit 120, into digital detection values to transfer the converted digital detection values to the driving unit 140.

The converting unit 130 may include a plurality of converters 131 to 13N, wherein the plurality of converters 131 to 13N may respectively correspond to the plurality of detectors 121 to 12N and a plurality of drivers 141 to 14N and convert the analog detection value from a corresponding detector into the digital detection value to transfer the converted digital detection value to a corresponding driver.

The driving unit 140 may set a switching duty cycle controlling driving of the plurality of light emitting diode channels L1 to LN according to the digital detection values from the converting unit 130 and may transfer a switching signal having the set switching duty cycle to the plurality of light emitting diode channels L1 to LN.

To this end, the driving unit 140 may include the plurality of drivers 141 to 14N, wherein the plurality of drivers 141 and 14N may respectively correspond to the plurality of light emitting diode channels L1 to LN such that the switching signal may be transferred to a corresponding light emitting diode channel, L1-LN. Meanwhile, each of the plurality of drivers 141 to 14N may receive a dimming signal PWM from the outside and drive the plurality of respective light emitting diode channels L1 to LN in the case in which the dimming signal PWM is a switching-on signal.

Each of the plurality of drivers 141 to 14N may set a switching duty cycle according to the digital detection value detected in a corresponding light emitting diode channel, L1-LN. More specifically, each of the plurality of drivers 141 to 14N may set a switching-on duty cycle so as to be lengthened when a voltage drop value in a corresponding light emitting diode channel, L1-LN, is relatively large, and may set the switching-on duty cycle so as to be short when a voltage drop value of the corresponding light emitting diode channel, L1-LN, is relatively low. Accordingly, the current flowing in the light emitting diode channels L1 to LN may be uniformly maintained with regard to an average current, whereby the plurality of light emitting diode channels L1 to LN may have uniform brightness and generate uniform amounts of heat due to a voltage drop deviation between the plurality of light emitting diode channels L1 to LN being reduced. In addition, the heat may be reduced as described above, whereby the light emitting diode driving apparatus according to the embodiment of the present invention may be implemented by at least one integrated circuit.

The light emitting diode driving apparatus according to the embodiment of the present invention may further include a plurality of switches M1 to MN. Each of the plurality of switches M1 to MN may be connected between the plurality of respective light emitting diode channels L1 to LN and the ground and be switched on or switched off according to the switching signal from the driving unit 140 to allow current to flow in the corresponding light emitting diode channel, L1-LN or block the current flowing in the corresponding light emitting diode channel, L1-LN.

In addition, the light emitting diode driving apparatus according to the embodiment of the present invention may further include a plurality of buffers B1 to BN each buffering the switching signals from each of the plurality of drivers 141 to 14N to transfer the buffered switching signal to a corresponding switch, M1-MN.

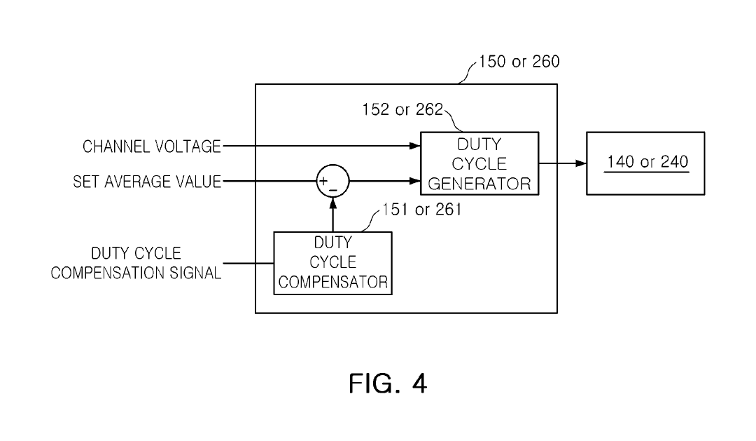

In addition, the light emitting diode driving apparatus 100 according to the embodiment of the present invention may further include a compensating unit 150. An error may occur in converting the analog signal from the detecting unit 120 into the digital signal in the converting unit 130. Therefore, since an error may occur in the duty cycle of the switching signal transferred from the driving unit 140 to the light emitting diode channels L1 to LN, the compensating unit 150 may need to compensate for the duty cycle of the switching signal. The compensating unit 150 will be described in more detail with reference to FIG. 4.

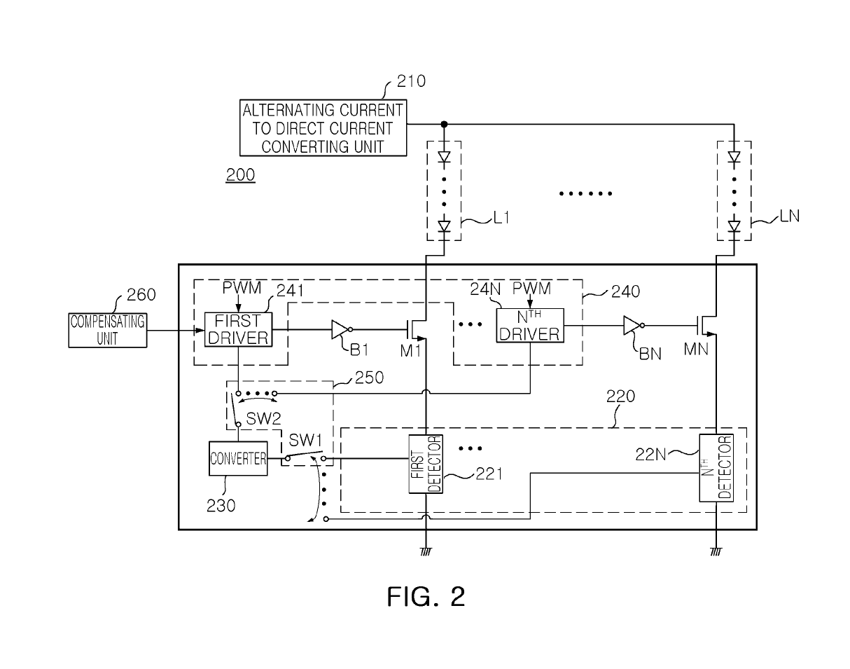

FIG. 2 is a diagram showing a light emitting diode driving apparatus according to another embodiment of the present invention.

Referring to FIG. 2, a light emitting diode driving apparatus 200 according to another embodiment of the present invention may include a switching unit 250. The switching unit 250 may include a first selection switch SW1 and a second selection switch SW2, wherein the first selection switch SW1 may selectively connect a converting unit 230 and a plurality of detectors 221 to 22N, and the second selection switch SW 2 may selectively connect between the converting unit 230 and a plurality of drivers 241 to 24N. Therefore, the number of converting units 230 may not be plural. Meanwhile, an AC to DC converting unit 210, a detecting unit 220, a driving unit 240, and a compensating unit 260 are same as the AC to DC converting unit 110, the detecting unit 120, the driving unit 140, and the compensating unit 160 described with reference to FIG. 1. Therefore, a detailed description thereof will be omitted.

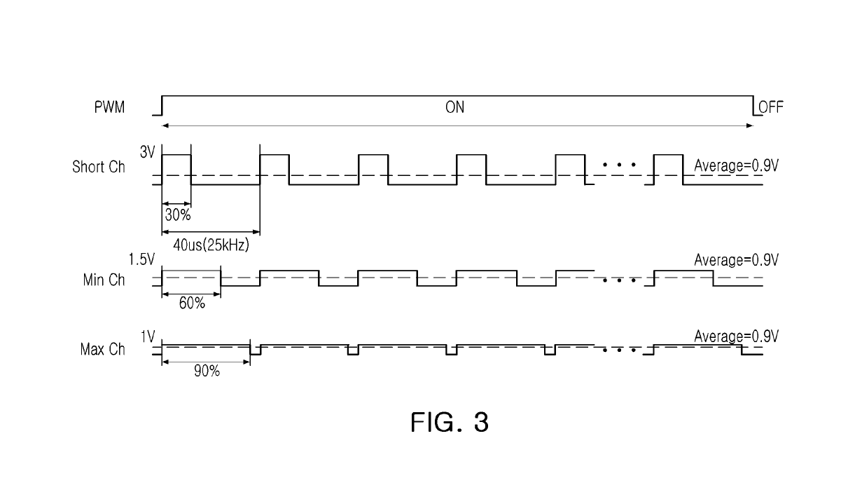

FIG. 3 is a graph showing an operation of the light emitting diode driving apparatus according to the embodiment of the present invention.

Referring to FIGS. 1 and 3, only when the dimming signal PWM from the outside is switched on, the driving unit 140 may transfer the switching signal to a corresponding light emitting diode channel, L1-LN. In this case, in the case that the voltage drop (1.5V) of the corresponding light emitting diode channel, L1-LN, exceeds a preset reference voltage level, the switching-on duty cycle in which the switches M1 to MN are switched on may be lengthened, for example, about 90%, and in the case that the voltage drop (1V) of the corresponding light emitting diode channel, L1-LN, is smaller than the preset reference voltage level, the switching-on duty cycle in which the switches M1 to MN are switched on may be shortened, for example, about 60% (Min Ch, Max Ch). That is, the switching-on duty cycle of the switching signal of the corresponding light emitting diode channel may be variably set according to a variation in voltage drops in the corresponding light emitting diode channel. Therefore, the average current flowing in the light emitting diode channels L1 to LN is uniformly maintained (as represented by a voltage of 0.9V), whereby the plurality of light emitting diode channels L1 to LN may have uniform brightness and the heat generated due to the voltage drop deviation between the plurality of light emitting diode channels L1 to LN may be reduced. In addition, in the case in which a short-circuit occurs in at least one of the plurality of light emitting diode channels L1 to LN, since the voltage drop is increased (3V), the switching-on duty cycle is set to be significantly shortened, for example, 30%, according to the voltage drops in the corresponding light emitting diode channel, whereby generated heat may be reduced.

The operation graph of FIG. 3 may be similarly applied to the light emitting diode driving apparatus 200 according to another embodiment of the present invention of FIG. 2.

FIG. 4 is a schematic configuration diagram of a compensating unit used in the light emitting diode driving apparatus according to the embodiment of the present invention.

Referring to FIG. 4, the compensating unit 150 may include a duty cycle compensator 151 or 261 and a duty cycle generator 152 or 262.

The duty cycle compensator 151 or 261 may compensate for an average value set according to a duty cycle compensation signal from the outside, and the duty cycle generator 152 or 262 may generate the duty cycle of the switching signal of the driving unit 140 or 240 according to the detected channel voltage of the plurality of light emitting diode channels L1 to LN and the compensated average value to provide the generated duty cycle to the driving unit 140 or 240.

As described above, according to the embodiments of the present invention, the switching-on duty cycles in which the driving current is allowed to flow in respective LED channels may be differentially set according to the voltage deviation between the LED channels, whereby heat generated due to the voltage deviation between the LED channels may be reduced, brightness in LED channels may be uniformly maintained, and the light emitting diode driving apparatus may be implemented through a single integrated circuit. In addition, since a DC to DC converter is not used, manufacturing costs may be decreased, the reliability of the circuit may be improved, and the miniaturization of the circuit may be achieved.

As set forth above, according to the embodiments of the present invention, the duty cycles in which the driving current is allowed to flow in respective LED channels are differentially set according to the voltage deviation between the LED channels, whereby the average current of the LED channels may be uniformly maintained and the heat generated due to the voltage deviation between the LED channels may be reduced.

While the present invention has been shown and described in connection with the embodiments, it will be apparent to those skilled in the art that modifications and variations can be made without departing from the spirit and scope of the invention as defined by the appended claims.

What is claimed is:

1. A light emitting diode driving apparatus, comprising:
an alternating current (AC) to direct current (DC) converting unit converting input AC power into a preset DC driving power;
a detecting unit detecting voltage drops in a plurality of respective light emitting diode channels each having a plurality of light emitting diodes performing a light emitting operation by receiving the DC driving power;
a converting unit converting analog values detected from the detecting unit into digital values; and
a driving unit differentially setting switching signal duty cycles in which a driving current is allowed to flow in the plurality of respective light emitting diode channels according to the digital values converted by the converting unit to drive the plurality of light emitting diode channels.

2. The light emitting diode driving apparatus of claim 1, wherein the detecting unit includes a plurality of detectors respectively corresponding to the plurality of light emitting diode channels and detecting the voltage drops in a corresponding light emitting diode channel.

3. The light emitting diode driving apparatus of claim 2, wherein the driving unit includes a plurality of drivers respectively corresponding to the plurality of light emitting diode channels and setting the duty cycles of the switching signals by which the driving current is allowed to flow in a corresponding light emitting diode channel to thereby be driven.

4. The light emitting diode driving apparatus of claim 3, wherein the converting unit includes a plurality of converters corresponding to the plurality of detectors and converting the analog value detected by each of the plurality of detectors into the digital value to transfer the converted digital value to a corresponding driver among the plurality of drivers.

5. The light emitting diode driving apparatus of claim 1, wherein the driving unit lengthens a switching-on duty cycle when the voltage drop exceeds a reference voltage and shortens the switching-on duty cycle when the voltage drop is lower than the reference voltage.

6. The light emitting diode driving apparatus of claim 1, wherein the detecting unit, the converting unit, and the driving unit are configured by at least one integrated circuit.

7. The light emitting diode driving apparatus of claim 1, further comprising a plurality of switches respectively connected between each of the plurality of light emitting diode channels and a ground, and turned on and turned off according to the switching duty cycle set by the driving unit to drive the corresponding light emitting diode channel.

8. The light emitting diode driving apparatus of claim 7, further comprising a plurality of buffers buffering a switching duty cycle signal from the driving unit to transfer the buffered switching duty cycle signal to a corresponding switche.

9. A light emitting diode driving apparatus, comprising:
an AC to DC converting unit converting input AC power into a preset DC driving power;
a detecting unit detecting voltage drops generated in a plurality of respective light emitting diode channels each having a plurality of light emitting diodes performing a light emitting operation by receiving the DC driving power;
a converting unit converting analog values detected from the detecting unit into digital values;
a driving unit differentially setting switching signal duty cycles in which a driving current is allowed to flow in the plurality of respective light emitting diode channels according to the digital values from the converting unit to drive the plurality of light emitting diode channels; and
a switching unit selecting a detection value having detected the voltage drops generated in each of the plurality of light emitting diode channels to transfer the selected detection value to the converting unit and selecting the digital value from the converting unit to transfer the selected digital value to the driving unit.

10. The light emitting diode driving apparatus of claim 9, wherein the detecting unit includes the plurality of detectors respectively corresponding to the plurality of light emitting diode channels and detecting the voltage drops in a corresponding light emitting diode channel.

11. The light emitting diode driving apparatus of claim 10, wherein the driving unit includes the plurality of drivers respectively corresponding to the plurality of light emitting diode channels and setting the duty cycles of the switching signals by which the driving current is allowed to flow in a corresponding light emitting diode channel to drive the corresponding light emitting diode channel.

12. The light emitting diode driving apparatus of claim 11, wherein the converting unit includes a plurality of converters corresponding to the plurality of detectors and converting the analog value detected by each of the plurality of detectors into the digital value to transfer the converted digital value to a corresponding driver among the plurality of drivers.

13. The light emitting diode driving apparatus of claim 9, wherein the switching unit includes:
a first selection switch selecting the detection value from each of the plurality of detectors to transfer the selected detection value to the converting unit; and
a second selection switch selecting the digital value from the converting unit to transfer the selected digital value to each of the plurality of drivers.

14. The light emitting diode driving apparatus of claim 12, wherein the converting unit includes a plurality of converters corresponding to the plurality of detectors and converting the analog value detected by each of the plurality of detectors into the digital value to transfer the converted digital value to each of the drivers among the plurality of drivers.

15. The light emitting diode driving apparatus of claim 9, wherein the driving unit lengthens a switching-on duty cycle when the voltage drop exceeds a reference voltage and shortens the switching-on duty cycle when the voltage drop is lower than the reference voltage.

16. The light emitting diode driving apparatus of claim 9, wherein the detecting unit, the converting unit, and the driving unit is configured by at least one integrated circuit.

17. The light emitting diode driving apparatus of claim 9, further comprising a plurality of switches respectively connected between each of the plurality of light emitting diode channels and a ground, and turned on and turned off according to the switching duty cycle set by the driving unit to drive the corresponding light emitting diode channel.

18. The light emitting diode driving apparatus of claim 17, further comprising a plurality of buffers buffering a switching duty cycle signal from the driving unit to transfer the buffered switching duty cycle signal to a corresponding switche.
